(19) United States
(12) Patent Application Publication
(10) Pub. No.: US 2016/0264077 A1
(43) Pub. Date: Sep. 15, 2016

(54) OPTIMIZED HVAC SYSTEM CONTROL FOR ELECTRIFIED VEHICLES

(71) Applicants: Rami Abousleiman, Auburn Hills, MI (US); Kamal Bouyoucef, Rochester, MI (US)

(72) Inventors: Rami Abousleiman, Auburn Hills, MI (US); Kamal Bouyoucef, Rochester, MI (US)

(21) Appl. No.: 14/657,242

(22) Filed: Mar. 13, 2015

(51) Int. Cl. B60R 16/03; B60H 1/00; B60L 7/10

(52) U.S. Cl. CPC B60R 16/03; B60L 7/10; B60H 1/00642

(57) ABSTRACT

A system for optimizing energy efficiency in an electrified vehicle includes an HVAC system configured to provide climate control for at least one of (i) a cabin of the electrified vehicle and (ii) a battery system of the electrified vehicle; a regenerative braking system configured to convert the electrified vehicle's kinetic energy into electrical energy; and a controller configured to, based on a vehicle torque request, control a distribution of the electrical energy generated by the regenerative braking system between (i) recharging a battery system of the electrified vehicle and (ii) powering the HVAC system. A method for controlling the HVAC system includes determining, at the controller of the electrified vehicle, the vehicle torque request, and based on the vehicle torque request, controlling, by the controller, the distribution of electrical energy generated by a regenerative braking system between (i) recharging the battery system and (ii) powering the HVAC system.

### FIELD

The present application relates generally to electrified vehicles and, more particularly, to optimized heating, ventilating, and air conditioning (HVAC) system control for electrified vehicles.

### BACKGROUND

An electrified vehicle is typically configured to utilize an electric motor to at least optimally generate drive torque to propel the electrified vehicle. In some implementations, the electrified vehicle includes a regenerative braking system configured to convert the vehicle's kinetic energy into electrical energy instead of having the kinetic energy converted into wasted heat by the vehicle's brakes. This electrical energy could be used, for example, to recharge a battery system of the electrified vehicle. The battery system, however, has restrictions as to how much energy/charge it is capable of storing and thus some of the electrical energy generated by the regenerative braking system could be lost. Thus, while such electrified vehicle systems work for their intended purpose, there remains a need for improvement in the relevant art.

### SUMMARY

In accordance with one aspect of the invention, a system for maximizing energy efficiency in an electrified vehicle is provided. In one exemplary implementation, the system includes a heating, ventilating, and air conditioning (HVAC) system configured to provide heating, ventilation, and air conditioning for at least one of (i) a cabin of the electrified vehicle and (ii) a battery system of the electrified vehicle; a regenerative braking system configured to convert kinetic energy of the electrified vehicle to electrical energy; and a controller configured to, based on a vehicle torque request, control a distribution of the electrical energy generated by the regenerative braking system between (i) recharging the battery system and (ii) powering the HVAC system.

In accordance with one aspect of the invention, a method for controlling an HVAC system of an electrified vehicle is provided. In one exemplary implementation, the method includes determining, at a controller of the electrified vehicle, a vehicle torque request and, based on the vehicle torque request, controlling, by the controller, a distribution of electrical energy generated by a regenerative braking system of the electrified vehicle between (i) recharging a battery system of the electrified vehicle and (ii) powering the HVAC system.

In one exemplary implementation, the controller is configured to control the distribution of the electrical energy generated by the regenerative braking system such that the HVAC system is supplied with an average actual power over a period equal to an average desired power of the HVAC system over the period. In one exemplary implementation, the controller is configured to control the distribution of the electrical energy generated by the regenerative braking system such that during the period the HVAC system is provided at least one of (i) an actual power less than its desired power and (ii) an actual power greater than its desired power.

In one exemplary implementation, the controller is configured to decrease the electrical energy provided from the regenerative braking system to the HVAC system in response to an increase in the vehicle torque request. In one exemplary implementation, the controller is configured to increase the electrical energy provided from the regenerate braking system to the HVAC system in response to a decrease in the vehicle torque request.

In one exemplary implementation, the controller is configured to control the distribution of the electrical energy generated by the regenerative braking system between (i) recharging a battery system of the electrified vehicle and (ii) powering the HVAC system during only non-highway driving by the electrified vehicle.

In one exemplary implementation, the battery system is configured to at least partially power both (i) an electric motor configured to generate drive torque to propel the electrified vehicle and (ii) the HVAC system.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is an example functional block diagram of an electrified vehicle according to the principles of the present disclosure;

FIGS. 2A-2B are example graphs relating actual and desired power for a heating, ventilating, and air conditioning (HVAC) system of an electrified vehicle and a vehicle torque request; and

FIG. 3 is an example flow diagram of a method for controlling an HVAC system of an electrified vehicle according to the principles of the present disclosure.

### DESCRIPTION

As previously discussed, at least some of the electrical energy generated by a regenerative braking system of an electrified vehicle could be lost due to restrictions on the battery system. Moreover, the battery system is configured to provide electrical energy to other components of the electrified vehicle, such as a heating, ventilating, and air conditioning (HVAC) system. Thus, in certain high demand scenarios, the battery system could be unable to output enough electrical energy (e.g., current) to the electric motor to meet a torque request. Accordingly, techniques are presented for optimized HVAC system control for electrified vehicles. The techniques include, based on a vehicle torque request, controlling a distribution of the electrical energy generated by the regenerative braking system between (i) recharging the battery system and (ii) powering the HVAC system. The techniques provide for increased energy efficiency (e.g., less or zero wasted electrical energy) and/or improved electrified vehicle responsiveness due to the lesser load on the battery system.

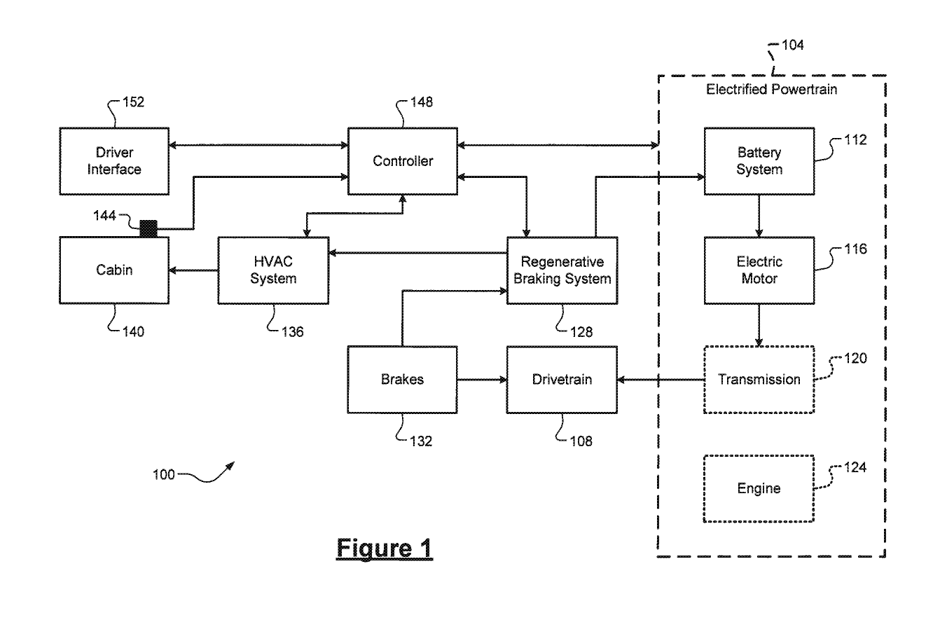

Referring now to FIG. 1, an example functional block diagram of an electrified vehicle 100 is illustrated. Non-limiting examples of the electrified vehicle 100 include a plug-in electrified electric vehicle (PHEV) and a battery electric vehicle (BEV). The electrified vehicle 100 could also be any other suitable type of hybrid or electric vehicle. The electrified vehicle 100 includes an electrified powertrain 104 that generates and transfers drive torque to a drivetrain 108. In one exemplary implementation, the electrified powertrain 104 includes a battery system 112, an electric motor 116, and an optional transmission 120. In one exemplary implementation, the electrified vehicle 100 further includes another battery (e.g., a 12 volt lead-acid battery) configured to power component(s) of the electrified vehicle 100. In one exemplary implementation, the electrified vehicle 100 further includes an engine 124 configured to combust an air/fuel mixture to generate drive torque for vehicle propulsion and/or recharging the battery system 112.

The electrified vehicle 100 includes a regenerative braking system 128 configured to convert kinetic energy of the electrified vehicle 100 into electrical energy (e.g., a current or power), such as when the electrified vehicle 100 is coasting or would otherwise be decelerating due to use of the brakes 132 of the electrified vehicle 100. As is known to those skilled in the art, a regenerative braking system converts the kinetic energy of the electrified vehicle into electrical energy by using the electric motor 116 as a generator instead of wasting such kinetic energy through conventional use of the brakes 132, which converts the excess kinetic energy into heat.

The electrified vehicle 100 also includes an HVAC system 136 configured to provide heating, ventilating, and air conditioning (climate control) to at least one of (i) cabin 140 of the electrified vehicle 100 and (ii) the battery system 112. For example only, the HVAC system 136 could be used to heat, cool, or otherwise ventilate the battery system 112 during extreme operating temperatures. In one exemplary implementation, the HVAC system 136 is controlled based on feedback from one or more temperature sensors 144 in the cabin 140. While temperature sensors 144 are shown and discussed herein, it will be appreciated that other suitable sensors could be additionally or alternatively utilized (e.g., humidity sensors). A controller 148 is configured to control operation of the electrified vehicle 100, such as controlling the electrified powertrain 104 and the HVAC system 136. Specifically, the controller 148 is configured to control the electrified powertrain 104 to output a desired torque corresponding to a vehicle torque request.

In one exemplary implementation, the vehicle torque request is provided via a driver interface 152 (e.g., an accelerator pedal). While the term vehicle torque request is used herein, it will be appreciated that the optimized HVAC control could also be performed based on an actual torque command (e.g., based on the vehicle torque request) by the controller 148 to the electrified powertrain 104. The driver interface 152 could also include controls enabling the driver to control the HVAC system 136 (a general on/off switch, cabin temperature set point controls, ventilation/fan controls, etc.)

In one exemplary implementation, the controller 148 is also configured to perform at least a portion of the techniques of the present disclosure. More particularly, the controller 148 is configured to, based on the vehicle torque request, control a distribution of the electrical energy generated by the regenerative braking system 128 between (i) recharging the battery system 112 and (ii) powering the HVAC system 136. In one exemplary implementation, the controller 148 is configured to control the HVAC system 136 such that an average power provided to the HVAC system 136 over a period equals a desired power for the HVAC system 136. This desired power for the HVAC system 136 represents a power for the HVAC system 136 to achieve requested parameters (airflow, cabin temperature, etc.). Thus, while the actual power provided to the HVAC system 136 may be lesser than and/or greater than its desired power over the period, the average actual power provided to the HVAC system 136 over the period should equal or approximately equal the average desired power over the period.

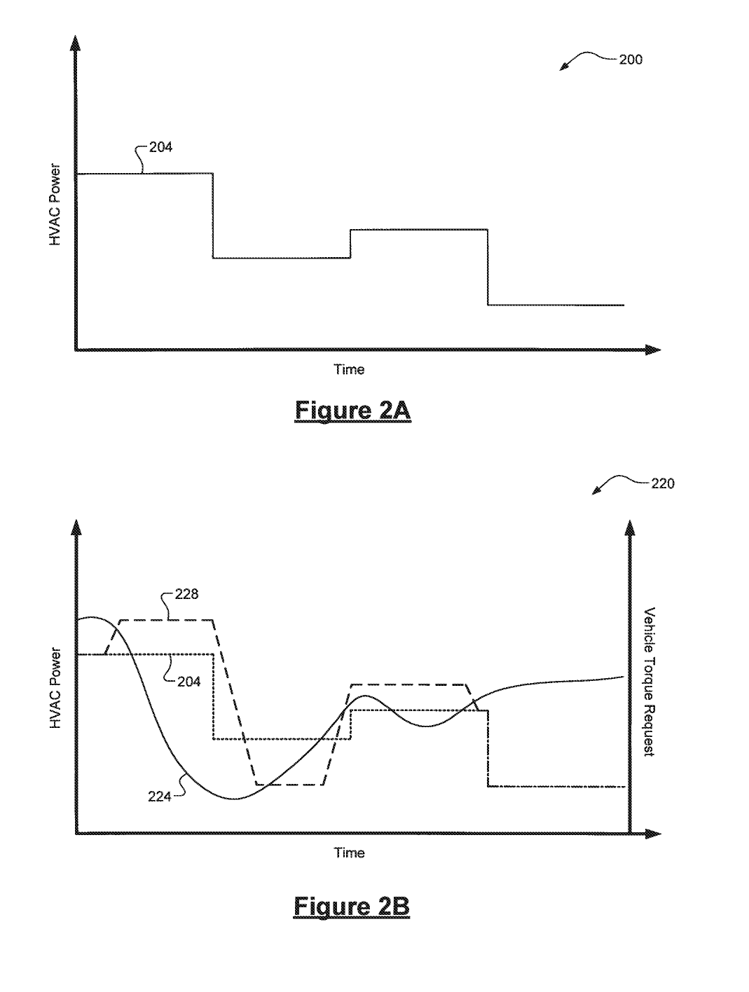

Referring now to FIGS. 2A-2B, example graphs relating HVAC actual and desired powers and vehicle torque request are illustrated. FIG. 2A illustrates a graph 200 of an example desired power 204 of the HVAC system 136 with respect to time. As previously discussed, this example desired power 204 could be based on the driver's settings and/or sensor feedback (airflow, temperature, etc.). FIG. 2B illustrates a graph 220 of the example desired power 204 in addition to an example vehicle torque request 224 and an example actual power 228 provided to the HVAC system 136 with respect to time. As shown, the actual power 228 provided to the HVAC system 136 increases when the vehicle torque request decreases, and vice-versa. An average actual power provided to the HVAC system 136 over the illustrated period, however, is equal to or approximately equal to the average desired power of the HVAC system 136 over the illustrated period. In other words, the system could prioritize power provisioning to the electrified powertrain 104 over the HVAC system 136, while also balancing the power provisioning such that the HVAC system 136 receives its average desired power.

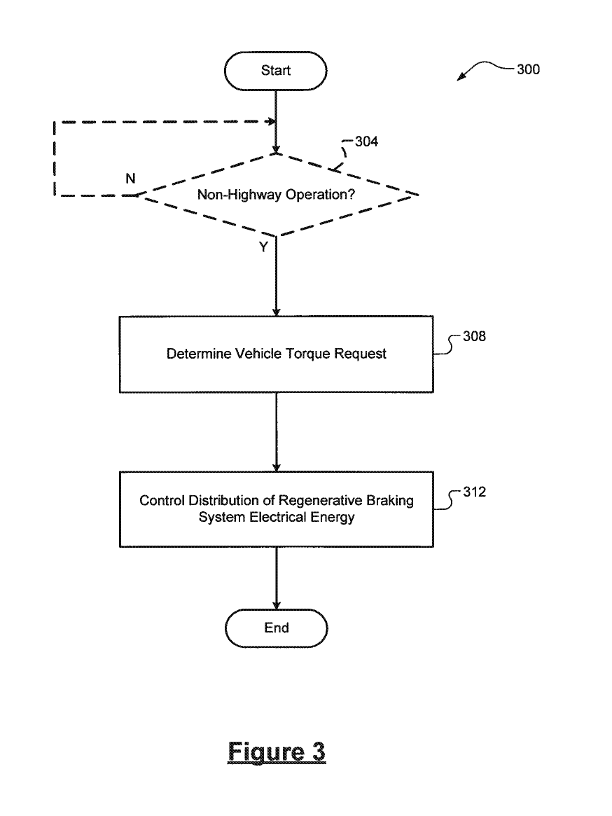

Referring now to FIG. 3, an example flow diagram of a method 300 of controlling the HVAC system 136 of the electrified vehicle 100 is illustrated. At 304, an optional determination is made whether the electrified vehicle 100 is currently under non-highway operation. If true, the method 300 proceeds to 308. If false, the method 300 optionally returns to 304. This determination could include an analysis of various driving conditions, such as changes in vehicle and/or electric motor speed (e.g., indicative of stop/go driving). This determination is optional because the vehicle torque request should remain relatively constant during highway driving, and thus the vehicle torque request-based HVAC control would likely not affect HVAC control during highway operation. In one exemplary implementation, however, the method 300 is only performed when the electrified vehicle 100 is performing non-highway operation. For example, in such an exemplary implementation, the power provisioning techniques could be disabled during highway operation. At 308, the controller 148 determines the vehicle torque request. At 312, based on the vehicle torque request, the controller 148 controls the distribution of the electrical energy generated by the regenerative braking system 128 between (i) recharging the battery system 112 and (ii) powering the HVAC system 136. The method 300 then ends or returns to 304 for one or more additional cycles.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

1. A system for optimizing energy efficiency in an electrified vehicle, the system comprising:
a heating, ventilating, and air conditioning (HVAC) system configured to provide at least one of heating, ventilation, and air conditioning for a battery system of the electrified vehicle;
a regenerative braking system configured to convert kinetic energy of the electrified vehicle to electrical energy; and
a controller configured to, based on a vehicle torque request, control a distribution of the electrical energy generated by the regenerative braking system between (i) recharging the battery system and (ii) powering the HVAC system.

2. The system of claim 1, wherein the controller is configured to control the distribution of the electrical energy generated by the regenerative braking system such that the HVAC system is supplied with (i) an average actual power over a period equal to (ii) an average desired power of the HVAC system over the period.

3. The system of claim 2, wherein the controller is configured to control the distribution of the electrical energy generated by the regenerative braking system such that during the period the HVAC system is provided at least one of (i) an actual power less than its desired power and (ii) an actual power greater than its desired power.

4. The system of claim 1, wherein the controller is configured to decrease the electrical energy provided from the regenerative braking system to the HVAC system in response to an increase in the vehicle torque request.

5. The system of claim 1, wherein the controller is configured to increase the electrical energy provided from the regenerate braking system to the HVAC system in response to a decrease in the vehicle torque request.

6. The system of claim 1, wherein the controller is configured to control the distribution of the electrical energy generated by the regenerative braking system between (i) recharging the battery system and (ii) powering the HVAC system during only non-highway driving by the electrified vehicle.

7. The system of claim 1, wherein the battery system is configured to at least partially power both (i) an electric motor configured to generate drive torque to propel the electrified vehicle and (ii) the HVAC system.

8. A method for controlling a heating, ventilating, and air conditioning (HVAC) system of an electrified vehicle, the method comprising:
determining, at a controller of the electrified vehicle, a vehicle torque request; and
based on the vehicle torque request, controlling, by the controller, a distribution of electrical energy generated by a regenerative braking system of the electrified vehicle between (i) recharging a battery system of the electrified vehicle and (ii) powering the HVAC system such that:
the HVAC system is supplied with an average actual power over a period equal to an average desired power of the HVAC system over the period, and
during the period, the HVAC system is supplied with at least one of (i) an actual power less than its desired power and (ii) an actual power greater than its desired power.

9-10. (canceled)

11. The method of claim 8, wherein controlling the distribution of the electrical energy includes decreasing the electrical energy provided from the regenerative braking system to the HVAC system in response to an increase in the vehicle torque request.

12. The method of claim 8, wherein controlling the distribution of the electrical energy includes increasing the electrical energy provided from the regenerate braking system to the HVAC system in response to a decrease in the vehicle torque request.

13. The method of claim 8, wherein the distribution of the electrical energy generated by the regenerative braking system between (i) recharging the battery system and (ii) powering the HVAC system is controlled during only non-highway driving by the electrified vehicle.

14. The method of claim 8, wherein the battery system is configured to at least partially power both (i) an electric motor configured to generate drive torque to propel the electrified vehicle and (ii) the HVAC system.

15. The system of claim 1, wherein the HVAC system is configured to provide at least one of ventilation and air conditioning for the battery system, and wherein the controller is configured to increase the electrical energy provided from the regenerate braking system to the HVAC system in response to an increase in a temperature of the battery system above an extreme high temperature threshold.

16. The system of claim 1, wherein the HVAC system is configured to provide heating for the battery system, and wherein the controller is configured to increase the electrical energy provided from the regenerate braking system to the HVAC system in response to a decrease in a temperature of the battery system below an extreme low temperature threshold.

17. The system of claim 1, wherein the HVAC system is further configured to provide heating, ventilation, and air conditioning for a cabin of the electrified vehicle.

18. The method of claim 8, wherein the HVAC system is configured to provide at least one of ventilation and air conditioning for the battery system, and wherein controlling the distribution of the electrical energy includes increasing the electrical energy provided from the regenerate braking system to the HVAC system in response to an increase in a temperature of the battery system above an extreme high temperature threshold.

19. The method of claim 8, wherein the HVAC system is configured to provide heating for the battery system, and wherein controlling the distribution of the electrical energy includes increasing the electrical energy provided from the regenerate braking system to the HVAC system in response to an decrease in a temperature of the battery system below an extreme cold temperature threshold.
